(19) United States
(12) Patent Application Publication
(10) Pub. No.: US 2019/0222413 A1
(43) Pub. Date: Jul. 18, 2019

(54) COUPLING A MOBILE RADIO TERMINAL TO A VEHICLE, AND MONITORING A COUPLING

(71) Applicant: Continental Teves AG & Co. OHG, Frankfurt (DE)

(72) Inventors: Marc MENZEL, Weimar (Lahn) (DE); Frank SEURER, Bad Vilbel (DE)

(21) Appl. No.: 16/308,052

(22) PCT Filed: Jun. 8, 2017
(86) PCT No.: PCT/EP2017/063928

§ 371 Date: Dec. 7, 2018

(30) Foreign Application Priority Data
Jun. 10, 2016 (DE) 10 2016 210 351.2

(51) Int. Cl. H04L 9/08; H04W 12/00; H04L 9/32; H04W 76/30; H04W 12/04

(52) U.S. Cl. CPC H04L 9/085; H04W 12/00403; H04L 9/3228; H04W 12/00503; H04W 76/30; H04W 12/0401; H04W 12/00516

(57) ABSTRACT

A mobile radio terminal is coupled to a control module of a vehicle. The control module is put into a coupling state and sends a secret to the mobile radio terminal to set up a coupling. The setup of a coupling is possible only if the control module is in the coupling state. Security is, therefore, increased when a vehicle is coupled to a mobile radio terminal. Both setup of the coupling and maintenance thereof are able to be monitored.

### BACKGROUND

The invention relates to a method for coupling a mobile radio terminal and to a method for monitoring a coupling.

The introduction of vehicle-to-vehicle and vehicle-to-infrastructure communication, also abbreviated to vehicle-to-X communication or C2X communication, will result in a sharp increase in ad-hoc network communication in the vicinity of vehicles. Increasingly, there will also be services and functions that need data that are not available in this vicinity, however. These data can be provided in future by mobile radio terminals, for example.

If a data communication between a mobile radio terminal and a vehicle is implemented in nonsecure fashion, then there is the risk of the connection being compromised. By way of example, a hacker can place himself between mobile radio terminal and vehicle and therefore concomitantly read or perhaps manipulate data, which would result in erroneous driving maneuvers by an autonomous vehicle, for example. To prevent this is a considerable increase in future road safety.

It is therefore an object of the invention to provide mechanisms that can make a data communication of this kind more secure.

### BRIEF SUMMARY

This is achieved according to the invention by a method as claimed in claim 1, a method as claimed in claim 5, a method as claimed in claim 9 and a method as claimed in claim 10. Advantageous refinements can be taken from the respective subclaims, for example. The content of the claims is incorporated in the content of the description by express reference.

The invention relates to a method for coupling a mobile radio terminal, in particular a cell phone, to a control module of a vehicle. Instead of a cell phone, however, the mobile radio may also be, by way of example, a mobile data terminal, such as, for example, a hotspot or another data communication device. It may also be a tablet, a computer with appropriate equipment or the like.

According to the invention, the method on the control module has the following steps:
putting the control module into a coupling state, and
sending, by means of the control module, a secret to the mobile radio terminal to set up a coupling,
the setup of a coupling being possible only if the control module is in the coupling state.

The method according to the invention advantageously allows a communication between a vehicle and a mobile radio terminal to be rendered secure. In this regard, it is first of all possible to ensure that the exchange or the sending of secrets can be effected only under precisely defined conditions, namely in the coupling state, which is in particular a state producible only by particular measures and/or only by authorized personnel. Mechanisms in this regard are described in more detail later on.

The secret can later be used as a first and a second secret. During operation, the two secrets can be compared, a manipulation advantageously being able to be detected if the two secrets are not concordant. For this case, a coupling is typically not maintained.

The setup or maintaining of unreliable couplings can therefore be effectively prevented by the method according to the invention.

The embodiment according to which the setup of a coupling is possible only in the coupling state achieves a particularly high level of security. This is because the authorization for setting up the coupling state can be restricted, for example to garages or other authorized personnel.

The secret or secrets may be numbers or alphanumeric codes or similar data, for example.

According to one advantageous embodiment, there is provision for the control module to be put into the coupling state by connecting a programmer. A programmer of this kind may in particular be a diagnostic tester. Diagnostic testers of this kind are frequently used in garages. This makes it possible to ensure that the coupling is possible only by personnel who have access to programmers or diagnostic testers of this kind, that is to say garage personnel, for example.

According to one embodiment, the programmer may have stored a temporary key and, after connection, can transmit it to the control module. According to an alternative embodiment, which is also combinable, however, the control module can be put into the coupling state as a result of reception of a temporary key from a server. A key of this kind may in particular be a particular code whose admissibility or validity can be detected by the control module. Only in the event of appropriate admissibility or validity is the coupling state then adopted, which means that a mobile radio terminal can be coupled. The temporary key can in particular be taken as a basis for ascertaining the secret. This can be effected by a formula, an algorithm or perhaps by identical adoption, for example. The secret can then in particular be transmitted to the mobile radio terminal and can also be stored, which means that it is later available for comparison purposes.

After setup of the coupling, the following steps are preferably carried out:
receiving, by means of the control module, a first secret from the mobile radio terminal,
comparing the first secret with a second secret, and
only if the first secret and the second secret are identical, maintaining the coupling between the control module and the mobile radio terminal.

It is thus possible for the coupling to be monitored. Should the secrets not be identical, this indicates a manipulation, for example an unauthorized intervention or an unauthorized terminal. These steps can be carried out, by way of example, continually at particular intervals or perhaps after or in response to particular events such as, for example, driving through particular areas or switching on an ignition of the vehicle.

It should be understood that a secret can also be sent from the control module to the mobile radio terminal and compared therein as appropriate.

The invention further relates to a method for coupling a mobile radio terminal, in particular a cell phone, to a control module of a vehicle.

According to the invention, the method on the mobile radio terminal has the following steps:
security check on an application, and
only if the security check delivers a positive result, transmitting a secret from the mobile radio terminal to the control module by means of the application or receiving a secret from the control module.

This method according to the invention advantageously allows a cell phone to be coupled to a vehicle or a coupling to be maintained and monitored. In this case, this method in particular describes those steps that are advantageously carried out on a cell phone. The security check on the application ensures that the application is secure, i.e. has not been manipulated or is not in a nonsecure environment, for example. It is thus possible for applicable attacks to be prevented.

The security check can preferably include a self-check by the application for changes or manipulations. This allows changes in the application, for example as a result of manipulated files being loaded or similar measures, to be advantageously detected.

The security check can in particular also include the check on an execution environment for lack of security or change. This can ensure that the application is executed in a secure environment, which means that a further gateway for possible manipulations is closed.

The security check can result in a number of checksums being produced and these can then be transmitted to the control module. Checksums of this kind can be used by the control module in particular to check whether the application and/or the execution environment have also actually not been manipulated. By way of example, only in this case is it possible for a coupling to be set up.

The invention further relates to a method for coupling a mobile radio terminal, in particular a cell phone, to a control module of a vehicle. In this case, the control module carries out a method as described earlier on with reference to the control module. The mobile radio terminal simultaneously carries out a method as described above with reference to the mobile radio terminal.

In regard to the respective methods, reference can be made to all of the embodiments and variants described herein. Explained advantages apply accordingly.

The method according to the invention that has just been presented, which relates both to the mobile radio terminal and to the control module, can advantageously be used to couple a mobile radio terminal to a control module of a vehicle. The security functions described earlier on can therefore be achieved in a particularly advantageous manner.

The invention further relates to a method for monitoring a coupling between a mobile radio terminal, in particular a cell phone, and a control module of a vehicle. According to the invention, the method has the following steps:
measuring a first parameter by means of the mobile radio terminal,
measuring a second parameter by means of the vehicle,
transmitting the first parameter and/or the second parameter between the mobile radio terminal and the control module,
determining a disparity between the first parameter and the second parameter,
comparing the disparity with a threshold value,
if the disparity is below the threshold value, maintaining the coupling or using respective data packets, and
if the disparity is above the threshold value, terminating the coupling or rejecting respective data packets.

This method according to the invention can be used to monitor a coupling between a mobile radio terminal and a control module of a vehicle continually in an advantageous manner. In this case, particular parameters can be monitored that are described in more detail later on.

It should be understood that the method has just been described in two possible embodiments, which are also combinable. First, a disparity above the threshold value can result in the coupling being terminated completely, which means that the mobile radio is no longer coupled and therefore also no longer available for the data transmission by the control module at least up until a next coupling or after a period of time or some other authorization has expired. According to an alternative embodiment, which is also combinable, however, as already mentioned, only respective data packets for which the threshold value is exceeded can be rejected. This allows a communication to be fundamentally maintained, with only single, possibly compromised data packets being rejected, for example, and therefore an attack on the system being hampered.

The mobile radio terminal and the control module of the vehicle have preferably been coupled by means of a method as described earlier on. As a further preference, the coupling takes place in this case if the disparity at the time of the coupling is below the threshold value. Therefore, the method for monitoring a coupling described earlier on can also advantageously be used to increase security during the actual setup of a coupling of this kind.

According to one embodiment, the first parameter and the second parameter are respective timestamps, in particular from satellite navigation. It is thus possible to monitor that the data transmission between mobile radio terminal and control module has taken a shorter time than a particular threshold value, which means that it can be assumed that the transmission was effected directly and not via a possibly interposed compromised concomitant reader or alterer.

According to one development, there is provision for respective data packets also to be rejected if a fluctuation in the disparity between the timestamps is above a threshold value. Therefore, even if the intervals between the respective timestamps are fundamentally below the threshold value mentioned earlier on, a fluctuation of appropriate level can result in a security measure in the form of rejection of data packets or perhaps termination of the coupling being taken, since in this case too it must be expected that there is a possible concomitant reader or alterer present in the communication.

According to one embodiment, the first parameter and the second parameter are a respective position, which can be determined in particular from satellite navigation. It is therefore possible to ensure that the vehicle and the mobile radio terminal are at the same location during the coupling. If the mobile radio terminal is removed from the vehicle, for example, this would be detected immediately with an embodiment of this kind. Manipulations are advantageously hampered thereby.

According to one embodiment, the first parameter and the second parameter are a respective acceleration and/or speed and/or direction of travel. It is thus advantageously possible to ensure that the cell phone is also in the vehicle during the journey, since it is then typically subject to the same speed and acceleration. A direction of travel can accordingly also be used as a parameter. Said direction of travel may also be part of the speed, in particular if the speed is considered as a vectorial variable. Any movements by the mobile radio terminal inside the vehicle can be taken into account by suitable algorithms.

Expressed in general terms, it is possible to refer to a possible security principle being able to be based on two pillars. This in particular firstly involves a secure initial registration of a mobile radio terminal in the vehicle network, for example on the vehicle-to-X controller, and secondly involves the plausibilization of a data connection during operation, which is intended to ensure that it is the registered terminal that is there.

First of all, possible setup of a secure connection between control module, in particular vehicle-to-X control module, and mobile radio terminal will be described.

For this purpose, garages require a certified diagnostic tester or similar hardware including a temporary key, for example. This key may be stored on the device in the garage or can be represented by a secure data connection to an OEM server (or both). Only if this data connection exists between diagnostic tester (or the like) and vehicle-to-X control module is it actually permissible for security-critical operations to be carried out, such as, for example, an initial coupling of a mobile radio terminal or other data radios.

Initial coupling means in particular that both devices (vehicle-to-X and mobile radio) store a shared secret in order to be able to use a “challenge-response method”. Initial coupling preferably likewise involves there being an app or application on the mobile radio terminal that has the following properties or functionalities:
performing a self-check in order to ensure that the app has not been manipulated or changed,
the app should check that its execution environment is secure and unaltered,
the app is supposed to transmit both checks to the vehicle-to-X control module for any coupling in the form of a checksum,
the reference checksums are transmitted for the initial coupling.

Both during the initial coupling and during operation, the following conditions preferably need to be satisfied:

In order to be able to interchange data between mobile radios and vehicle-to-X control devices or control modules without a “man in the middle”, all message packets should bear a GPS-synchronized timestamp. If delays above a threshold, which may be 20 ms, for example, arise, the data packets should be rejected, since in this case there is an increasing likelihood of a device having been interposed. Greatly fluctuating (below the threshold) latencies should also result in data packets that come from the mobile radio terminal being rejected. Since both measures will result in a certain number of data packets being rejected, the communication between mobile radio terminal and vehicle-to-X control module is supposed to cope with a correspondingly high packet error rate, which can be achieved using suitable TCP parameters, for example.

For a data communication between a mobile radio terminal and a vehicle-to-X control module actually to be able to take place, there is advantageously provision for the respective GNSS (global navigation satellite system) positions of both devices to be able to differ from one another only by less than a threshold of, by way of example, 10 m in order to actually set up the coupling.

During operation, there is advantageously provision for the following conditions to need to be satisfied in order for the data connection to be able to be rendered secure:
should the vehicle move, the heading or direction of travel and speed (±error tolerance) of vehicle and mobile radio terminal must be the same.
if the vehicle moves, accelerations acting on the vehicle must also correlate in some form in the mobile radio terminal by means of the sensors thereof.

The invention further relates to a control module and a mobile radio terminal that are configured to carry out a respective method according to the invention. The invention further relates to a nonvolatile, computer-readable storage medium which contains program code, during the execution of which a processor carries out a method according to the invention. In respect of the method, reference can be made to all of the described embodiments and variants.

Further features and advantages will be gathered by a person skilled in the art from the exemplary embodiment described below with reference to the appended drawing, in which:

### BRIEF DESCRIPTION OF THE DRAWINGS

FIG. 1 shows a vehicle having a mobile radio terminal according to an exemplary embodiment of the invention.

### DETAILED DESCRIPTION

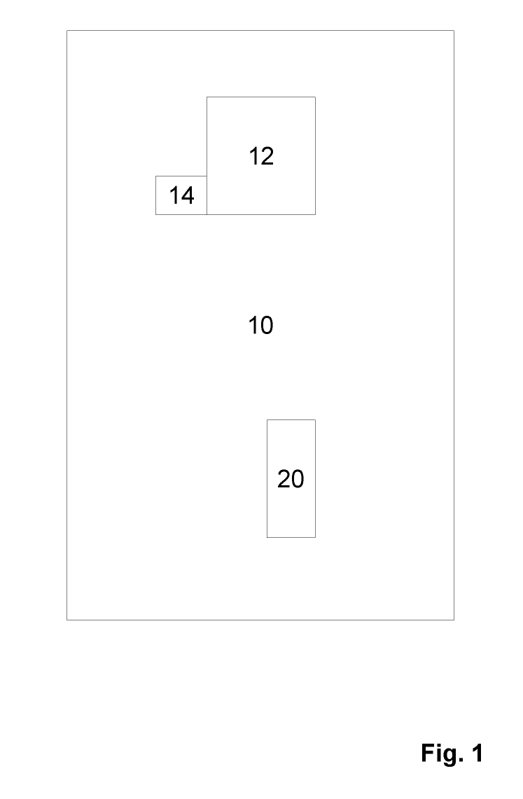

FIG. 1 shows a vehicle 10. The vehicle 10 has a vehicle-to-X control module 12. Further, the vehicle 10 contains a mobile radio terminal 20 in the form of a cell phone, the mobile radio terminal 20 being supposed to be coupled to the vehicle-to-X control module 12.

To this end, a diagnostic tester 14 is first of all fitted to the vehicle-to-X control module 12. A diagnostic tester 14 of this kind is typically available just in garages or to other authorized personnel. This puts the vehicle-to-X control module 12 into a coupling state that fundamentally permits mobile radio terminals to be coupled. To this end, an appropriate key is transmitted from the diagnostic tester 14 to the vehicle-to-X control module 12.

After the vehicle-to-X control module 12 has been put into the coupling state, an application running on the mobile radio terminal 20 is executed thereon. Said application is used for coupling and first of all checks itself and its application environment for whether it has been manipulated. This involves a checksum being produced and transmitted to the vehicle-to-X control module 12. If the checksum has a valid value, the coupling can be continued. This ensures that the application or its execution environment has not been manipulated.

Subsequently, a check is performed to determine whether the exchange of data packets results in respective timestamps of the data packets, which come from respective GPS modules not depicted in more detail, that is to say from satellite navigation, being less than a predetermined threshold value away from one another. If this is the case, the coupling can be continued. To this end, the vehicle-to-X control module 12 then transmits a secret in the form of an alphanumeric code to the mobile radio terminal 20, this secret also remaining stored in the vehicle-to-X control module 12.

After an initial coupling of this kind, the coupling can be checked continually. To this end, it is in particular possible for the secret stored on the mobile radio terminal 20 to be transmitted to the vehicle-to-X control module 12, which means that it can be compared with the secret stored in the vehicle-to-X control module 12. If the two secrets are concordant, then the mobile radio terminal 20 and the vehicle-to-X control module 12 remain coupled to one another. Consequently, a reliable and secure data transmission is thus possible in future.

During a coupling in progress, a data interchange is continuously performed that relates to the respective speeds and accelerations of vehicle 10 and mobile radio terminal 20. These are compared. If they are significantly apart for a lengthy period, that is to say in particular more than a particular threshold value, then applicable data packets are rejected or the coupling is broken. As a result, it is possible to prevent the coupling from being maintained if the cell phone 20 is no longer even in the vehicle and has possibly been manipulated.

In general, it should be pointed out that vehicle-to-X communication is understood to mean in particular a direct communication between vehicles and/or between vehicles and infrastructure devices. By way of example, it may thus be vehicle-to-vehicle communication or vehicle-to-infrastructure communication. Where this application refers to a communication between vehicles, said communication can fundamentally take place as part of a vehicle-to-vehicle communication, for example, which is typically effected without switching by a mobile radio network or a similar external infrastructure and which must therefore be distinguished from other solutions based on a mobile radio network, for example. By way of example, a vehicle-to-X communication can be effected using the IEEE 802.11p or IEEE 1609.4 standard. A vehicle-to-X communication can also be referred to as C2X communication. The subregions can be referred to as C2C (car-to-car) or C2I (car-to-infrastructure). However, the invention explicitly does not exclude vehicle-to-X communication with switching via a mobile radio network, for example.

Mentioned steps of the method according to the invention can be executed in the indicated order. However, they can also be executed in a different order. In one of its embodiments, for example with a specific combination of steps, the method according to the invention can be executed in such a way that no further steps are executed. However, in principle, further steps can also be executed, even steps of a kind which have not been mentioned.

The claims that are part of the application do not represent any dispensing with the attainment of further protection.

If it turns out in the course of the proceedings that a feature or a group of features is not absolutely necessary, then the applicant aspires right now to a wording for at least one independent claim that no longer has the feature or the group of features. This may be, by way of example, a subcombination of a claim present on the filing date or may be a subcombination of a claim present on the filing date that is limited by further features. Claims or combinations of features of this kind requiring rewording can be understood to be covered by the disclosure of this application as well.

It should further be pointed out that configurations, features and variants of the invention that are described in the various embodiments or exemplary embodiments and/or shown in the figures can be combined with one another in any way. Single or multiple features can be interchanged with one another in any way. Combinations of features arising therefrom can be understood to be covered by the disclosure of this application as well.

Back-references in dependent claims are not intended to be understood as dispensing with the attainment of independent substantive protection for the features of the back-referenced subclaims. These features can also be combined with other features in any way.

Features that are disclosed only in the description or features that are disclosed in the description or in a claim only in conjunction with other features may fundamentally be of independent significance essential to the invention. They can therefore also be individually included in claims for the purpose of distinction from the prior art.

1. A method for coupling a mobile radio terminal, in particular a cell phone, to a control module of a vehicle, wherein the method on the control module has the following steps:
putting the control module into a coupling state, and
sending, by means of the control module, a secret to the mobile radio terminal to set up a coupling,
the setup of a coupling being possible only if the control module is in the coupling state.

2. The method as claimed in claim 1,
wherein the control module is put into the coupling state by connecting a programmer, in particular a diagnostic tester;
wherein the programmer has preferably stored a temporary key and, after the connection, transmits it to the control module, and the control module takes the temporary key as a basis for ascertaining the secret.

3. The method as claimed in claim 2,
wherein the control module is put into the coupling state as a result of reception of a temporary key from a server, and the control module takes the temporary key as a basis for ascertaining the secret.

4. The method as claimed in claim 3, wherein after setup of the coupling the following steps are carried out:
receiving, by means of the control module, a first secret from the mobile radio terminal,
comparing the first secret with a second secret, and
only if the first secret and the second secret are identical, maintaining the coupling between the control module and the mobile radio terminal.

5. A method for coupling a mobile radio terminal, in particular a cell phone, to a control module of a vehicle, wherein the method on the mobile radio terminal has the following steps:
security check on an application, and
only if the security check delivers a positive result, transmitting a secret from the mobile radio terminal to the control module by means of the application or receiving a secret from the control module.

6. The method as claimed in claim 5,
wherein the security check includes a self-check by the application for change or manipulation.

7. The method as claimed in claim 6,
wherein the security check includes a check on an execution environment for lack of security or change.

8. The method as claimed in claim 7,
wherein the security check results in a number of checksums being produced and these being transmitted to the control module.

9. The method as claimed in claim 8,
wherein the control module carries out a method comprising:
putting the control module into a coupling state, and
sending, by means of the control module, a secret to the mobile radio terminal to set up a coupling,
the setup of a coupling being possible only if the control module is in the coupling state,
wherein the control module is put into the coupling state by connecting a programmer, in particular a diagnostic tester;
wherein the programmer has preferably stored a temporary key and, after the connection, transmits it to the control module, and the control module takes the temporary key as a basis for ascertaining the secret,
wherein the control module is put into the coupling state as a result of reception of a temporary key from a server, and the control module takes the temporary key as a basis for ascertaining the secret,
wherein after setup of the coupling the following steps are carried out:
receiving, by means of the control module, a first secret from the mobile radio terminal,
comparing the first secret with a second secret, and
only if the first secret and the second secret are identical, maintaining the coupling between the control module and the mobile radio terminal.

10. A method for monitoring a coupling between a mobile radio terminal, in particular a cell phone, and a control module of a vehicle,
wherein the method comprises the following steps:
measuring a first parameter by means of the mobile radio terminal,
measuring a second parameter by means of the vehicle,
transmitting the first parameter and/or the second parameter between the mobile radio terminal and the control module,
determining a disparity between the first parameter and the second parameter,
comparing the disparity with a threshold value,
if the disparity is below the threshold value, maintaining the coupling or using respective data packets, and
if the disparity is above the threshold value, terminating the coupling or rejecting respective data packets.

11. The method as claimed in claim 10,
wherein the mobile radio terminal and the control module of the vehicle have been coupled by means of a method wherein the method on the control module has the following steps:
putting the control module into a coupling state, and
sending, by means of the control module, a secret to the mobile radio terminal to set up a coupling,
the setup of a coupling being possible only if the control module is in the coupling state,
wherein the control module is put into the coupling state by connecting a programmer, in particular a diagnostic tester;
wherein the programmer has preferably stored a temporary key and, after the connection, transmits it to the control module, and the control module takes the temporary key as a basis for ascertaining the secret,
wherein the control module is put into the coupling state as a result of reception of a temporary key from a server, and the control module takes the temporary key as a basis for ascertaining the secret,
receiving, by means of the control module, a first secret from the mobile radio terminal,
comparing the first secret with a second secret, and
only if the first secret and the second secret are identical, maintaining the coupling between the control module and the mobile radio terminal,
wherein the method on the mobile radio terminal has the following steps:
security check on an application, and
only if the security check delivers a positive result, transmitting a secret from the mobile radio terminal to the control module by means of the application or receiving a secret from the control module,
wherein the security check includes a self-check by the application for change or manipulation,
wherein the security check includes a check on an execution environment for lack of security or change,
wherein the security check results in a number of checksums being produced and these being transmitted to the control module,
and wherein the coupling takes place only if the disparity at the time of the coupling is below the threshold value.

12. The method as claimed in claim 11,
wherein the first parameter and the second parameter are respective timestamps, in particular from satellite navigation.

13. The method as claimed in claim 12,
wherein respective data packets are also rejected if a fluctuation in the disparity between the timestamps is above a threshold value.

14. The method as claimed in claim 13,
wherein the first parameter and the second parameter are a respective position, in particular from satellite navigation.

15. The method as claimed in claim 14,
wherein the first parameter and the second parameter are a respective acceleration and/or speed and/or direction of travel.
